(19) United States
(12) Patent Application Publication
(10) Pub. No.: US 2025/0237092 A1
(43) Pub. Date: Jul. 24, 2025

(54) Support Structure for Modular Units with Drawer Interlock

(71) Applicant: Milwaukee Electric Tool Corporation, Brookfield, WI (US)

(72) Inventor: George Barton, Mequon, WI (US)

(21) Appl. No.: 18/977,396

(22) Filed: Dec. 11, 2024

Related U.S. Application Data
(60) Provisional application No. 63/623,493, filed on Jan. 22, 2024.
(60) Provisional application No. 63/554,447, filed on Feb. 16, 2024.
(60) Provisional application No. 63/571,629, filed on Mar. 29, 2024.

(51) Int. Cl. E05B 65/463; B25H 3/02

(52) U.S. Cl. CPC E05B 65/463; B25H 3/028

(57) ABSTRACT

One or more support platforms for a modular system are provided. The support platforms are configured to detachably support and couple with modular units, such as modular tool storage units. The support platforms include one or more components that include couplers configured to couple to modular tool storage units. The support platform includes sliding drawers and a drawer locking element that limits the number of drawers that can be fully extended from the housing.

### CROSS-REFERENCE TO RELATED PATENT APPLICATIONS

The present application claims the benefit of and priority to U.S. Provisional Application No. 63/571,629 filed on Mar. 29, 2024, U.S. Provisional Application No. 63/554,447 filed on Feb. 16, 2024, and U.S. Provisional Application No. 63/623,493 filed on Jan. 22, 2024, each which is incorporated herein by reference in its entirety.

### BACKGROUND OF THE INVENTION

The present disclosure is directed generally to the field of containers and related devices. The present disclosure relates specifically to support structures configured to support and detachably couple to utility modules (e.g., units) within a modular system.

Tool storage units are often used to transport tools and tool accessories. Some storage units are designed to incorporate into a modular storage system. Various support structures can be configured to support units within a modular system, such as a platform for storing units within a modular system.

### SUMMARY OF THE INVENTION

One embodiment of the invention relates to a support platform including a platform housing, a plurality of drawers slidably coupled to the platform housing, a plurality of female couplers, and a locking plate slidably engaged with the platform housing. Each of the plurality of drawers actuate between a retracted position in which the respective drawer is fully within the platform housing and an extended position in which the respective drawer extends at least partially outside the platform housing. Each of the plurality of female couplers are located along an upper surface of a drawer of the plurality of drawers, and each of the plurality of female couplers are configured to detachably and rigidly couple a modular tool storage device to the drawer the female coupler is located on. Each of the plurality of female couplers includes a recessed surface and a rib extending over the recessed surface. The locking plate interfaces with each of the plurality of drawers, and the locking plate actuates between a locked position and an unlocked position. The locking plate actuates from the unlocked position to the locked position in response to any of the plurality of drawers actuating from the retracted position to the extended position. The locking plate actuates from the locked position to the unlocked position in response to a drawer of the plurality of drawers actuating from the extended position to the retracted position. When the locking plate is in the locked position, no drawers of the plurality of drawers can be actuated from the retracted position to the extended position.

Another embodiment of the invention relates to a support platform including a platform housing, a plurality of drawers slidably coupled to the platform housing, a plurality of female couplers, and a plurality of switches coupled to the platform housing. Each of the plurality of drawers actuate between a retracted position in which the respective drawer is fully within the platform housing and an extended position in which the respective drawer extends at least partially outside the platform housing. The plurality of drawers includes a first drawer and a second drawer. Each of the plurality of female couplers are located along an upper surface of a drawer of the plurality of drawers. Each of the plurality of female couplers are configured to detachably and rigidly couple a modular tool storage device to the drawer the female coupler is located on. Each of the plurality of female couplers includes a recessed surface and a rib extending over the recessed surface. The plurality of switches actuates between a locking position and a unlocked position. The plurality of switches includes a first switch interfacing with the first drawer and a second switch interfacing with the second drawer. The first switch actuates from the unlocked position to the locking position in response to the first drawer actuating from the retracted position towards the extended position. When the first switch is in the locking position the second drawer is prevented from actuating from the retracted position to the extended position. The second switch actuates from the unlocked position to the locking position in response to the second drawer actuating from the retracted position towards the extended position. When the second switch is in the locking position the first drawer is prevented from actuating from the retracted position to the extended position.

Another embodiment of the invention relates to a storage system including a modular tool storage device and a support platform. The modular tool storage device includes a lower surface and a plurality of male couplers extending from the lower surface. Each of the plurality of male couplers includes a body extending from the lower surface and two tongues extending from the body in opposing directions offset from and displaced from the lower surface. The support platform includes a platform housing, a plurality of drawers slidably coupled to the platform housing, a plurality of female couplers, and a locking plate slidably engaged with the platform housing. Each of the plurality of drawers actuates between a retracted position in which the respective drawer is fully within the platform housing and an extended position in which the respective drawer extends at least partially outside the platform housing. Each of the plurality of female couplers are located along an upper surface of a drawer of the plurality of drawers. Each of the plurality of female couplers are configured to engage with the plurality of male couplers thereby detachably and rigidly coupling the modular tool storage device to the drawer the female coupler is located on. The locking plate interfaces with each of the plurality of drawers. The locking plate actuates between a locked position and an unlocked position. The locking plate actuates from the unlocked position to the locked position in response to any of the plurality of drawers actuating from the retracted position to the extended position. The locking plate actuates from the locked position to the unlocked position in response to a drawer of the plurality of drawers in the extended position actuating from the extended position to the retracted position. When the locking plate is in the locked position no drawers of the plurality of drawers can be actuated from the retracted position to the extended position.

Another embodiment of the invention relates to a support platform including a housing, a plurality of drawers slidably coupled to the housing, a plurality of female couplers, and a drawer locking element slidably engaged with the housing. Each of the plurality of drawers actuates between a retracted position in which the respective drawer is fully within the housing and an extended position in which the respective drawer extends at least partially outside the housing. The drawer locking element interfaces with each of the plurality of drawers. The drawer locking element actuates between a locked position and an unlocked position such that the drawer locking element actuates from the unlocked position to the locked position in response to any of the plurality of drawers actuating from the retracted position to the extended position, and the drawer locking element actuates from the locked position to the unlocked position in response to a drawer of the plurality of drawers actuating from the extended position to the retracted position. When the drawer locking element is in the locked position, no drawers of the plurality of drawers can be actuated from the retracted position to the extended position.

In a specific embodiment, the plurality of drawers includes a first drawer and a second drawer. The support platform includes a plurality of locking element actuators rotatably coupled to the housing, the plurality of locking element actuators including a first locking element actuator interfacing with the first drawer and a second locking element actuator interfacing with the second drawer. The first locking element actuator includes a first projection that interfaces with the first drawer when the first drawer actuates from the retracted position to the extended position thereby causing the first locking element actuator to rotate in a first direction with respect to the housing. The first locking element actuator includes a second projection that interfaces with the drawer locking element to slide the drawer locking element in a second direction with respect to the housing in response to the first locking element actuator rotating in the first direction, and the drawer locking element actuates from the unlocked position to the locked position as a result of the drawer locking element sliding in the second direction.

In a specific embodiment, the first locking element actuator includes a third projection that interfaces with the first drawer when the first drawer actuates from the extended position to the retracted position thereby causing the first locking element actuator to rotate in a third direction opposite the first direction with respect to the housing. The first locking element actuator permits the drawer locking element to slide in a fourth direction opposite the second direction in response to the first locking element actuator rotating in the third direction. The drawer locking element actuates from the locked position to the unlocked position as a result of the drawer locking element sliding in the fourth direction.

In a specific embodiment, each of the plurality of female couplers extend from a upper surface of a drawer of the plurality of drawers, and each of the plurality of female couplers are configured to detachably and rigidly couple a utility module to the respective drawer.

In a specific embodiment, each of the plurality of female couplers includes a recessed surface, a backwall, a first sidewall, and an opposing second sidewall opposite the first sidewall. Each of the backwall, the first sidewall and the second sidewall extend upward from the recessed surface. Each of the plurality of female couplers further includes a first rib extending from the backwall and the first sidewall above, offset from, and parallel to the recessed surface and a second rib extending from the backwall and the second sidewall above, offset from, and parallel to the recessed surface.

Another embodiment of the invention relates to a support platform including a housing, a plurality of drawers slidably coupled to the housing, a plurality of female couplers, each of the plurality of female couplers extending from a upper surface of a drawer of the plurality of drawers, a plurality of switches coupled to the housing, and an arm slidably engaged with the housing. The plurality of drawers includes a first drawer and a second drawer. Each of the plurality of drawers actuates between a retracted position in which the respective drawer is fully within the housing and an extended position in which the respective drawer extends at least partially outside the housing. Each of the plurality of female couplers are configured to detachably and rigidly couple a modular tool storage device to the respective drawer. The plurality of switches includes a first switch interfacing with the first drawer and a second switch interfacing with the second drawer. The arm actuates between a locked position and an unlocked position. The first switch actuates the arm from the unlocked position to the locked position in response to the first drawer actuating from the retracted position towards the extended position, and the first switch actuates the arm from the locked position to the unlocked position in response to the first drawer actuating from the extended position to the retracted position. When the arm is in the locked position, then no drawers of the plurality of drawers can be actuated from the retracted position to the extended position.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a schematic perspective view of a support platform, according to an exemplary embodiment.

FIG. 2 is a cross-section view of the support platform of FIG. 1, according to an exemplary embodiment.

FIG. 3 is a cross-section view of the support platform of FIG. 1, according to an exemplary embodiment.

FIG. 4 is a perspective view of a female coupler of the support platform of FIG. 1, according to an exemplary embodiment.

FIG. 5 is a perspective view of a male coupler that couples to the female coupler of FIG. 4, according to an exemplary embodiment.

FIG. 6 is an exploded view of components of another support platform, according to an exemplary embodiment.

FIG. 7 is an exploded view of a switch of the support platform of FIG. 6, according to an exemplary embodiment.

FIG. 8 is a perspective view of a portion of the support platform of FIG. 6, according to an exemplary embodiment.

FIG. 9 is a cross-section view of a portion of the support platform of FIG. 6, according to an exemplary embodiment.

FIG. 10 is a cross-section view of a portion of the support platform of FIG. 6, according to an exemplary embodiment.

FIG. 11 is a cross-section view of a portion of the support platform of FIG. 6, according to an exemplary embodiment.

FIG. 12 is a cross-section view of a portion of the support platform of FIG. 6, according to an exemplary embodiment.

FIG. 13 is a cross-section view of a portion of the support platform of FIG. 6, according to an exemplary embodiment.

FIG. 14 is a cross-section view of a portion of the support platform of FIG. 6, according to an exemplary embodiment.

FIG. 15 is a perspective view of a portion of the support platform of FIG. 6, according to an exemplary embodiment.

FIG. 16 is a perspective view of a portion of the support platform of FIG. 6, according to an exemplary embodiment.

FIG. 17 is a perspective view of a support platform, according to another exemplary embodiment.

FIG. 18 is a perspective view of a portion of the support platform of FIG. 17, according to an exemplary embodiment.

FIG. 19 is a perspective view from behind of a portion of the support platform of FIG. 17, according to an exemplary embodiment.

FIG. 20 is a cross-section view of a portion of the support platform of FIG. 17, according to an exemplary embodiment.

### DETAILED DESCRIPTION

Referring generally to the figures, a support platform that supports utility modules within a modular system is shown. In various embodiments, the support platform and structure discussed herein includes multiple slidable drawers and an element that limits the number of drawers that can be extended from the support platform, such as only allowing a single drawer to be extended from the support platform at a time.

In use, the support platform described herein can be used with vehicles, such as by placing the support platform in the storage area of a vehicle, such as a van, and optionally securing the support platform to a wall of the vehicle. Alternatively, the support platform can be placed in a room, where the support platform is optionally free-standing and is not secured to a wall. Applicant has found that limiting the number of drawers that can be extended at one time can improve the stability of the support platform when the support platform is not secured to a wall.

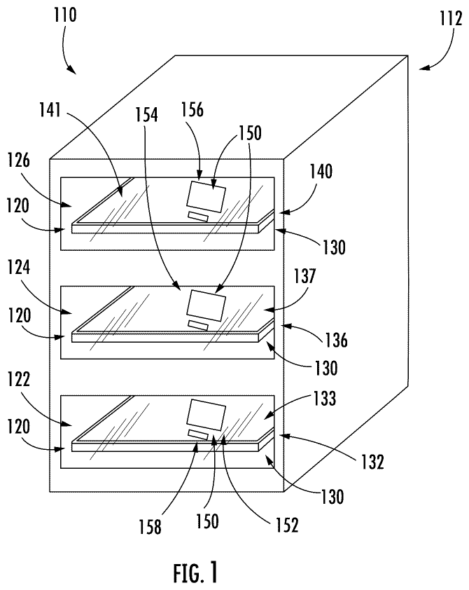

Referring to FIG. 1, various aspects of a mechanism, shown as support platform 110, for supporting and storing utility modules are shown. Support platform 110 includes platform housing 112, a plurality of drawers 130 slidably coupled to platform housing 112, and female couplers 150 and latch recesses 158 located on drawers 130. As will be explained, female couplers 150 and latch recesses 158 cooperatively, detachably, and rigidly couple a utility module, such as a modular tool storage unit, to drawers 130. In various embodiments, a plurality of female couplers 150 are located along upper surfaces 133, 137, 141 of drawers 132, 136, 140.

Each of the plurality of drawers 130 actuates between a retracted position in which the respective drawer 130 is fully within the platform housing 112 within one of compartments 120 and an extended position in which the respective drawer 130 extends at least partially outside the platform housing 112. First drawer 132 extends and retracts out of first compartment 122, second drawer 136 extends and retracts out of second compartment 124, and third drawer 140 extends and retracts out of third compartment 126.

First drawer 132 includes upper surface 133 facing upward, first female coupler 152 extending from upper surface 133, and latch recess 158. Second drawer 136 includes upper surface 137 facing upward, and second female coupler 154 extending from upper surface 137. Third drawer 140 includes upper surface 141 facing upward, and third female coupler 156 extending from upper surface 141. In various embodiments, each of drawers 130 includes at least one female coupler 150 and at least one latch recess 158.

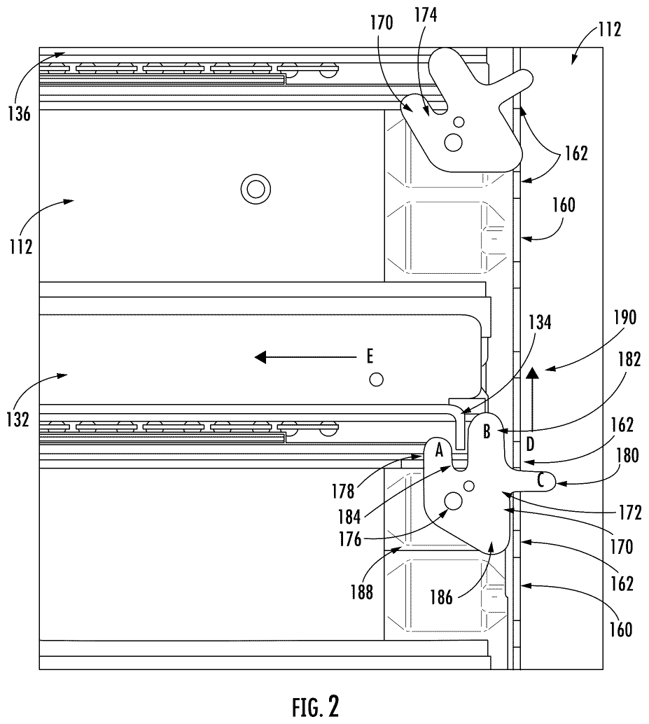

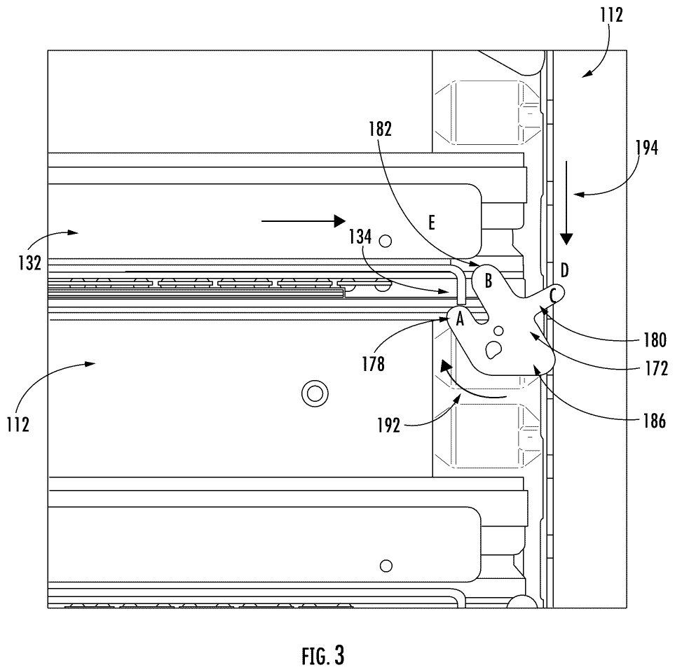

Referring to FIGS. 2-3, various aspects of drawers 130 sliding with respect to platform housing 112 are shown. In particular, support platform 110 includes a drawer locking element, shown as arm 160, and a plurality of locking element actuators, shown as switches 170, such as first switch 172 and second switch 174, that interface with drawers 130 to limit the number of drawers 130 that can be extended from platform housing 112.

Arm 160 slidably engages with platform housing 112 such that arm 160 interfaces with each of the plurality of drawers 130. Arm 160 actuates between a locked position and an unlocked position. As will be explained, arm 160 actuates from the unlocked position to the locked position in response to any of the plurality of drawers 130 actuating from the retracted position to the extended position, and arm 160 actuates from the locked position to the unlocked position in response to a drawer 130 of the plurality of drawers 130 actuating from the extended position to the retracted position. When arm 160 is in the locked position, no drawers 130 of the plurality of drawers 130 can be actuated from the retracted position to the extended position.

Referring to FIG. 2, when first drawer 132 is in the retracted position, protrusion 134 extends from first drawer 132 within recess 184 of first switch 172 between first projection 178 and third projection 182. When the first drawer 132 actuates from the retracted position to the extended position, protrusion 134 interfaces with first projection 178 thereby causing the first switch 172 to rotate in direction 188 about axis 176 with respect to platform housing 112. Second projection 180 of first switch 172 interfaces with arm 160 (e.g., with a protrusion 162 of arm 160) to slide arm 160 in direction 190 with respect to platform housing 112 in response to first switch 172 rotating in direction 188. As a result, arm 160 actuates into the locked position. In particular, arm 160 actuates from the unlocked position to the locked position in response to first switch 172, or any of switches 170, rotating in direction 188 with respect to platform housing 112. In various embodiments, first switch 172 interfaces with a detent, such as a recess defined by platform housing 112, to bias the first switch 172 to remain in the locked position.

When arm 160 is in the locked position, arm 160 prevents additional drawers 130 from being extended from platform housing 112, such as via protrusions 162 of arm 160 interfacing with switches 170 (e.g., fourth projection 186 of switch 172) to prevent and/or bias the retracted drawers 130 from being extended from platform housing 112.

Referring to FIG. 3, when first drawer 132 actuates from the extended position to the retracted position, protrusion 134 interfaces with third projection 182 of first switch 172 thereby causing first switch 172 to rotate in direction 192 opposite direction 188 with respect to the platform housing 112. As a result, first switch 172 permits arm 160 to slide in direction 194 opposite direction 190, such as due to gravity pulling arm 160 in direction 194, in response to first switch 172 rotating in direction 192. As a result, arm 160 actuates into the unlocked position. In particular, arm 160 actuates from the locked position to the unlocked position in response to first switch 172 rotating in direction 192 with respect to platform housing 112.

Referring to FIG. 4, various aspects of female couplers 150 are shown. Female coupler 150 includes a recessed surface 214. Backwall 216, opposing front wall 222, first sidewall 218, and opposing second sidewall 220 extend upward from recessed surface 214. Female coupler 150 includes a pocket 224 collectively defined by recessed surface 214, backwall 216, front wall 222, first sidewall 218, and second sidewall 220.

First rib 226 extends from backwall 216 and first sidewall 218 above pocket 224 and/or recessed surface 214. In particular, first rib 226 extends in direction 232 from first sidewall 218 and first rib 226 extends in direction 230 from backwall 216. Second rib 228 extends from backwall 216 and second sidewall 220 above pocket 224 and/or recessed surface 214. In particular, second rib 228 extends in direction 234 from second sidewall 220 and second rib 228 extends in direction 230 from backwall 216. To couple a male coupler to female coupler 150, the male coupler moves in direction 212 with respect to the female coupler 150 until one or more tongues of a male coupler are below ribs 226, 228, and a latch extends into latch recess 158 thereby limiting sliding displacement of the object including the male coupler with respect to the respective drawer 130.

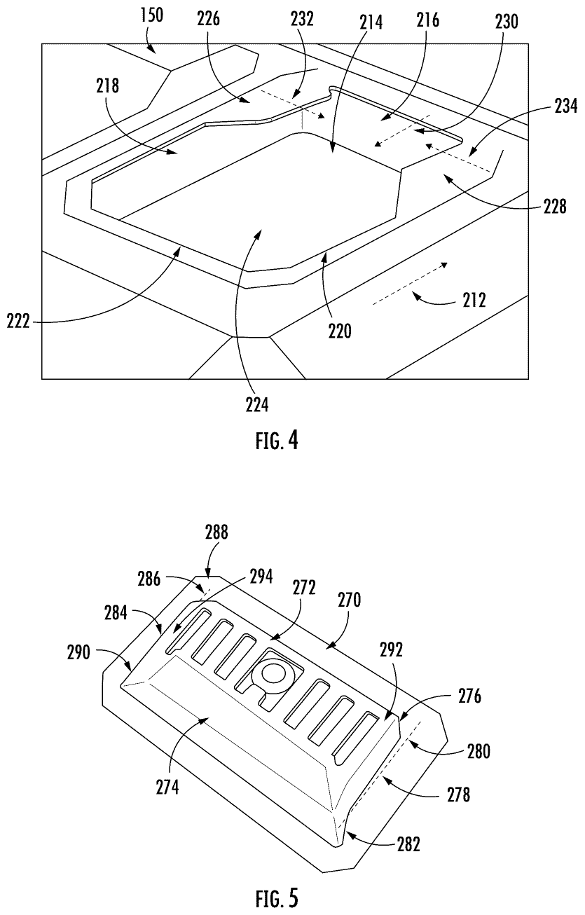

Referring to FIG. 5, in various embodiments, the utility modules that couple to drawers 130 include one or more male couplers 272 that couple to female couplers 150. Male coupler 272 includes a body 274 extending from a surface 270 of the utility module, a first tongue 276, and a second tongue 284. The first tongue 276 and the second tongue 284 both extend from the body 274 and both are offset from and above the surface 270. The first tongue 276 defines a first channel 278 between the surface 270 and the first tongue 276, and the second tongue 284 defines a second channel 286 between the surface 270 and the second tongue 284. The first channel 278 and second channel 286 each extend on opposing sides (e.g., first side 292 and opposing second side 294) of the body 274. Each of first channel 278 and second channel 286 includes a front open end and a back closed end. For example, first channel 278 includes a front open end 280 and a back closed end 282, and second channel 286 includes a front open end 288 and a back closed end 290.

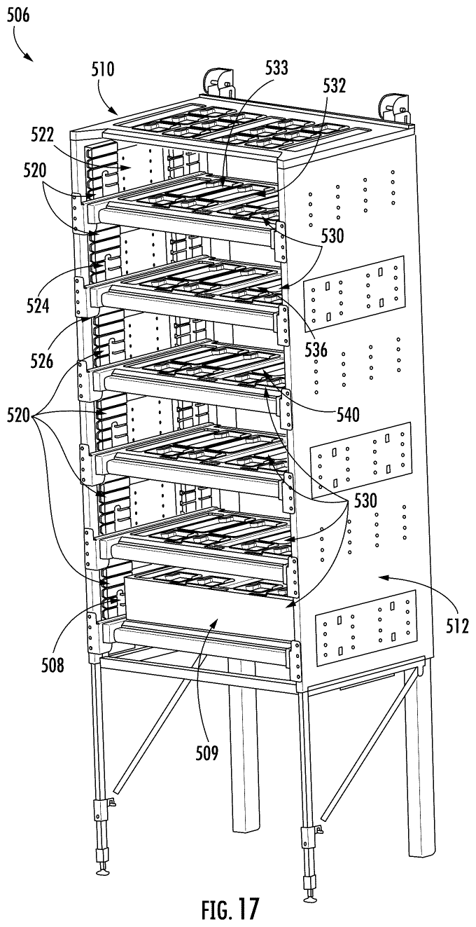

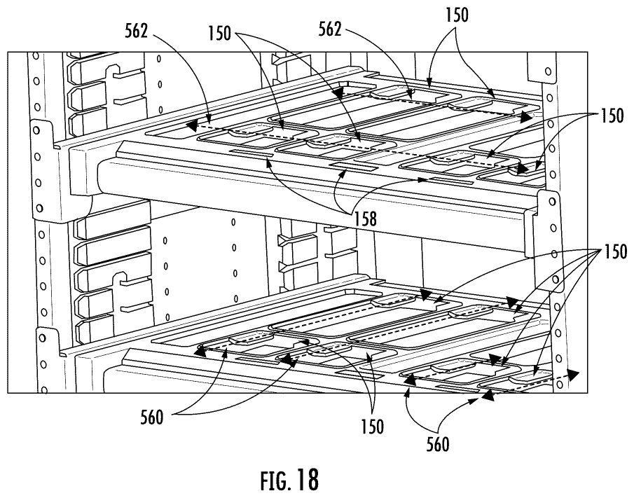

In various embodiments, each of the plurality of male couplers 272 includes a body 274 extending from the lower surface (e.g., lower surface 509 in FIG. 17), two tongues 276, 284 extending from the body 274 in opposing directions offset from and displaced from the lower surface.

In a specific embodiment, female couplers 150, latch recesses 158, female couplers 350, latch recesses 359, and male couplers 272 are compatible with the coupling mechanism(s) described in International Patent International Patent Publication No. WO/2017/191628, which is hereby incorporated by reference in its entirety.

In various embodiments, exterior surfaces of support platform 110 include female couplers 150 and/or male couplers 272 to facilitate coupling support platform 110 within a modular system. In a specific embodiment, upper surface of support platform 110 includes one or more female couplers 150 and bottom surface of support platform 110 includes one or more male couplers 272. In use, support platform 110 is coupled to upper surface of a first utility module that includes one or more female couplers 150 on the upper surface, and/or a second utility module that includes one or more male couplers 272 is coupled to the upper surface of support platform 110.

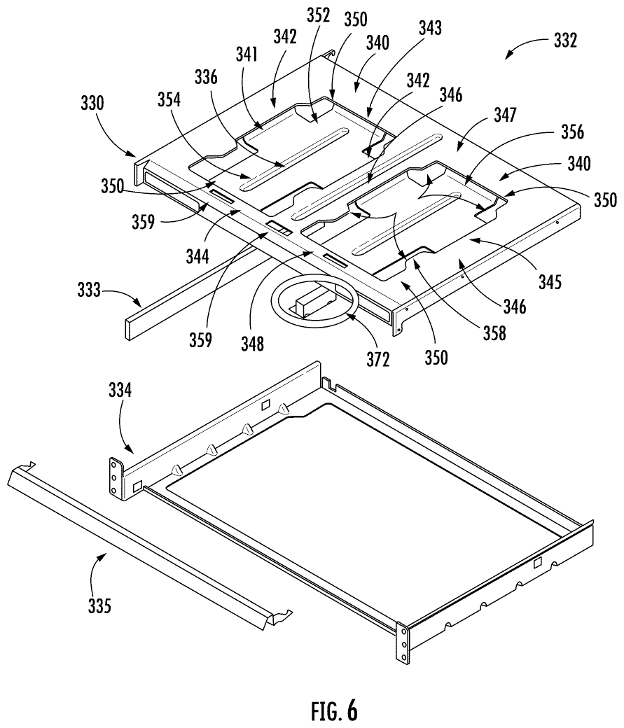

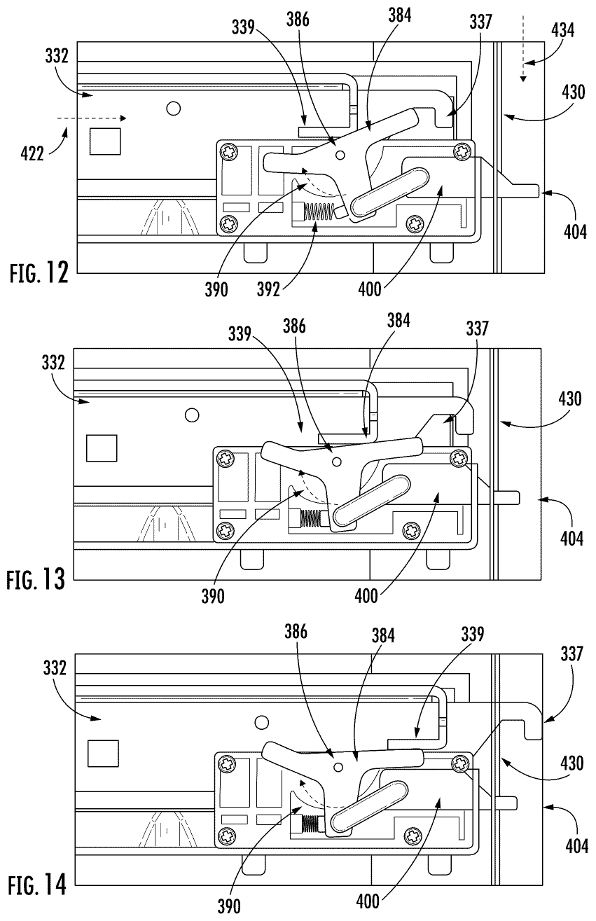

Referring to FIGS. 6-16, various aspects of support platform 310 are shown. Support platform 310 is substantially the same as support platform 110 except for the differences discussed herein.

Referring to FIG. 6, various aspects of drawer 332 are shown. Support platform 310 includes drawer 332. Drawer 332 includes female couplers 350, including female coupler 352, female coupler 354, female coupler 356, and female coupler 358, each of which include two ribs 351 extending into the respective female coupler 350. Drawer 332 includes latch recesses 359, configured to receive a latch extending from a utility module coupled to drawer 332, the latch and latch recess 359 preventing disengagement, such as sliding disengagement, between the utility module and drawer 332. Utility modules are detachably coupled, such as rigidly coupled, to drawer 332 via coupling to one or more of female couplers 350 and a latch interfacing with a latch recess 359.

Tray 334 is coupled to platform housing 312 of support platform 310, slides 333 are coupled to tray 334, and drawer 332 is coupled to slides 333. In use, drawer 332 extends out of and retracts into platform housing 312 of support platform 310.

Drawer 332 includes pockets 340, such as first pocket 341 and second pocket 345 within upper surface 336 of drawer 332. First pocket 341 includes female coupler 352, female coupler 354, wall 343, wall 344, and sidewalls 342 extending between wall 343 and wall 344. Second pocket 345 includes female coupler 356, female coupler 358, wall 347, wall 348, and sidewalls 346 extending between wall 347 and wall 348. Drawer 332 includes latch 335 to facilitate opening or closing drawer 332.

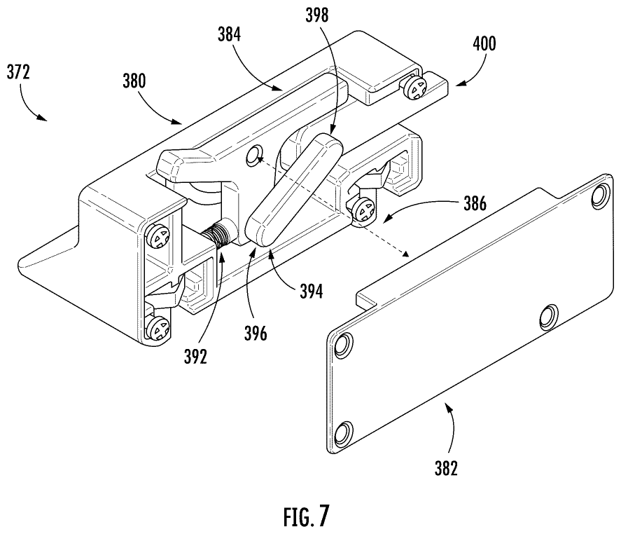

Referring to FIG. 7, various aspects of switch 372 are shown. Switch 372 includes housing 380, faceplate 382, and cam 384 pivotally coupled to housing 380 such that cam 384 rotates around axis 386 with respect to housing 380. Switch 372 includes spring 392 coupled to housing 380 and cam 384. First end 396 of arm 394 is coupled to cam 384, and second end 398 of arm 394, opposite first end 396, is coupled to piston 400. As will be explained, piston 400 extends from and retracts into platform housing 312 as drawers 330 are extended and retracted from support platform 310.

Referring to FIG. 8, support platform 310 includes platform housing 312, drawers 330, including drawer 332 and drawer 338, and compartments 320, including compartment 322 and compartment 324. Drawer 332 extends and retracts within compartment 322, and drawer 338 extends and retracts within compartment 324. When drawer 332 is extended, piston 400 slides into locking plate 430, thereby biasing locking plate 430 in direction 432. As a result, hooked projection 337 extending from drawer 338 is engaged with locking plate 430, thereby biasing and/or preventing drawer 338 from being extended. In this way, the support platform 310 prevents more than one drawer 330 from being extended at the same time.

Locking plate 430 includes first plurality of apertures 440 and second plurality of apertures 450. Apertures 440 includes aperture 442, through which piston 400 of drawer 332 extends, and aperture 444, through which piston 400 of drawer 338 extends. Apertures 450 includes aperture 452, through which hooked projection 337 of drawer 332 extends, and aperture 456, through which hooked projection 337 of drawer 338 extends. When locking plate 430 is in the locked position, plate 454 below aperture 452 interfaces with hooked projection 337 of drawer 332 to prevent drawer 332 from being extended, and plate 458 below aperture 456 interfaces with hooked projection 337 of drawer 338 to prevent drawer 338 from being extended.

When drawer 332 is extended from platform housing 312, plate 339 no longer interfaces with cam 384. As a result, spring 392 causes cam 384 to rotate in direction 388, which causes projection 404 of piston 400 to extend through aperture 442 in locking plate 430. As will be explained, projection 404 extending through aperture 442 causes locking plate 430 to slide in direction 432, which locks hooked projection 337 of second drawer 338 against locking plate 430, thereby preventing second drawer 338 from being extended from platform housing 312.

Support platform 310 includes a plurality of switches 370, including switch 372 interfacing with drawer 332 and switch 374 interfacing with drawer 338. Switches 370 regulate how many drawers 330 can be extended from platform housing 312 at one time.

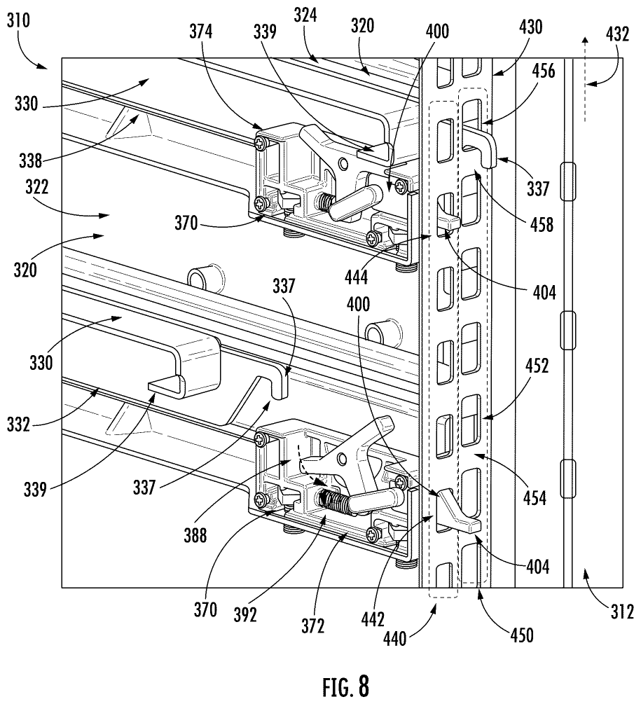

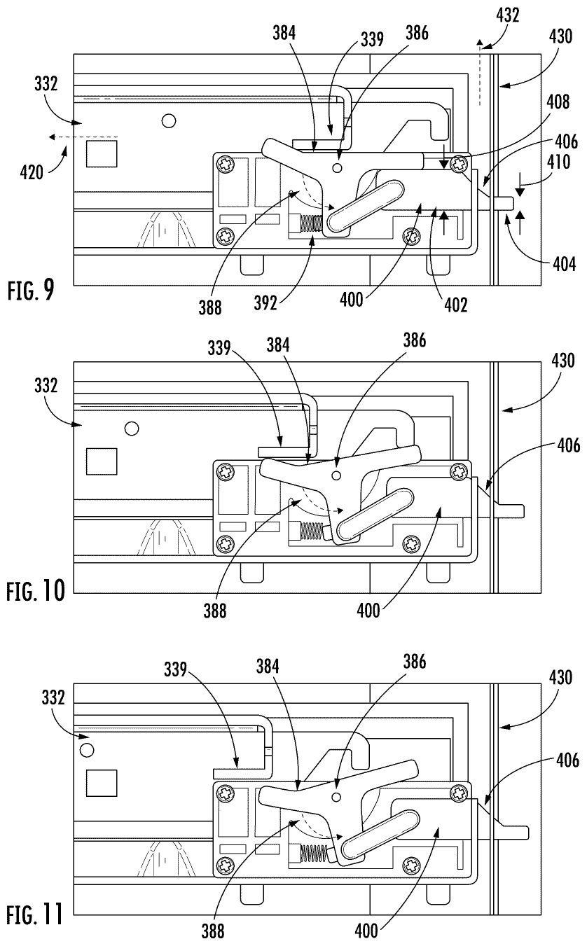

FIGS. 9-11 provide a series of images of drawer 332 as drawer 332 is extended. Initially, plate 339 of drawer 332 interfaces with cam 384 to prevent cam 384 from rotating in direction 388. When drawer 332 is moved in direction 420 thereby extending drawer 332 from platform housing 312, locking plate 339 does not interface with cam 384, which permits spring 392 to cause cam 384 to rotate in direction 388 around axis 386.

As a result, piston 400 extends through locking plate 430 causing locking plate 430 to move in direction 432. Piston 400 includes body 402, defining height 408, and projection 404, defining height 410, extending from body 402. Chamfered surface 406 of piston 400 extends from height 408 to height 410. As piston 400 is extended through locking plate 430, chamfered surface 406 of piston 400 interfaces with locking plate 430 to move locking plate 430 in direction 432. This movement actuates locking plate 430 into the locked position, which causes hooked projection 337 of drawers 330 other than drawer 332 to interface with locking plate 430 and thereby be prevented from being extended from platform housing 312.

FIGS. 12-14 provide a series of images of drawer 332 as drawer 332 is moved from the extended position to the retracted position. Initially (FIG. 12), drawer 332 is extended from platform housing 312. As drawer 332 is moved in direction 422, locking plate 339 of drawer 332 interfaces with cam 384 to rotate cam 384 in direction 390 around axis 386. As a result of the rotation of cam 384 in direction 390, piston 400 is partially retracted, which causes locking plate 430 to move in direction 434, such as due to gravity.

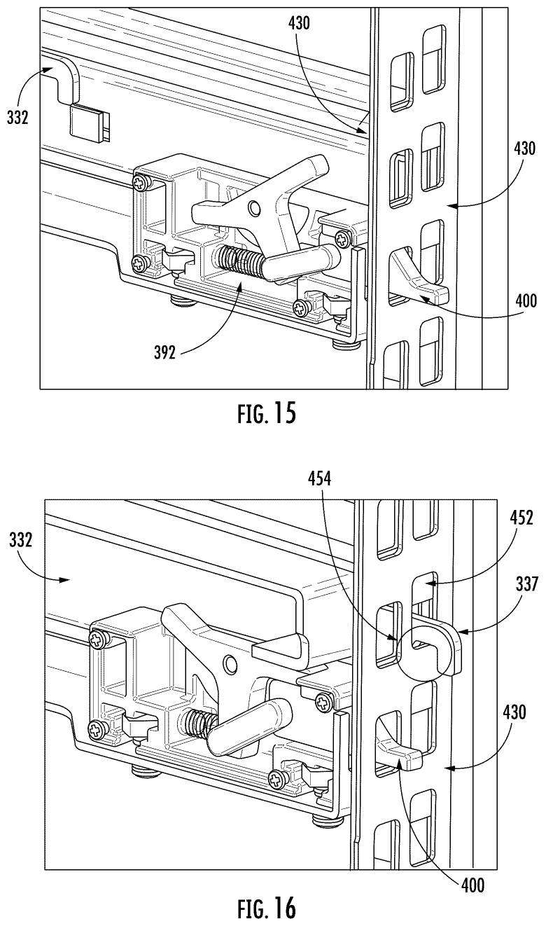

Referring to FIGS. 15-16, when drawer 332 is extended from support platform 310, piston 400 engages with locking plate 430 to slide locking plate 430 upward in FIG. 15, thereby locking the remaining drawers 330 in place. Referring to FIG. 16, drawer 332 is prevented from being extended when locking plate 430 has been slid upward (e.g., is in the locked position) as a result of hooked projection 337 of drawer 332 interfacing with plate 454 of locking plate 430 to prevent drawer 332 from being extended.

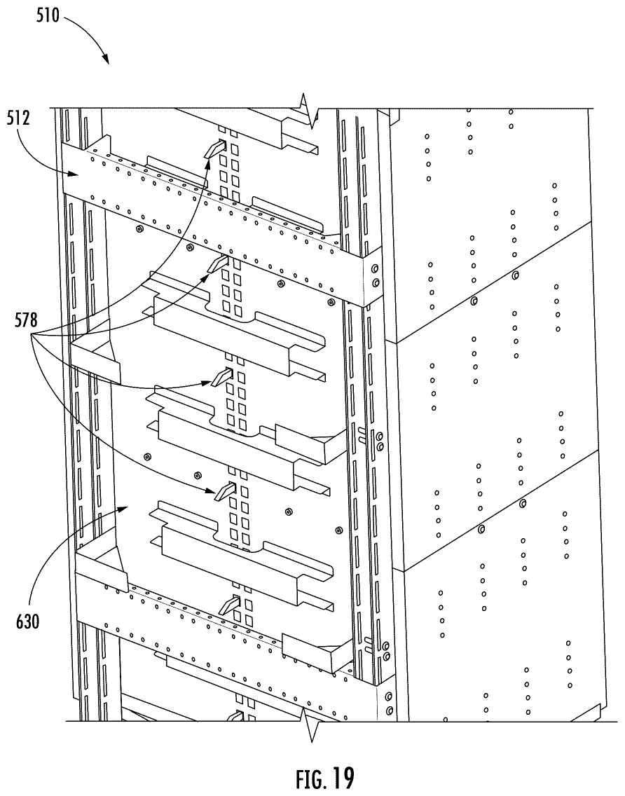

Referring to FIGS. 17-20, various aspects of support platform 510 are shown. Support platform 510 is substantially the same as support platform 110 or support platform 310 except for the differences discussed herein.

Storage system 506 includes support platform 510 and modular tool storage device 508. As will be described, modular tool storage device 508 includes a plurality of male couplers (e.g., see FIG. 5) and a latch configured to interface with latch recess 158 of drawers 530. In various embodiments, modular tool storage device 508 includes a lower surface 509 and a plurality of male couplers, such as male couplers 272 shown in FIG. 5, extending from the lower surface 509.

Support platform 510 includes platform housing 512, a plurality of drawers 530 slidably coupled to platform housing 512, a plurality of female couplers 150 and one or more latch recesses 158 located along an upper surface of the plurality of drawers 530. Drawers 530 include first drawer 532, second drawer 536, and third drawer 540. Platform housing 512 defines compartments 520 into which drawers 530 slide out of and retract into, including first drawer 532 sliding into and out of first compartment 522, second drawer 536 sliding into and out of second compartment 524, and third drawer 536 sliding into and out of third compartment 526. As will be explained, female couplers 150 and latch recesses 158 cooperatively, detachably, and rigidly couple a utility module, such as a modular tool storage unit, to drawers 530. In various embodiments, a plurality of female couplers 150 are located along upper surfaces of drawers 530, such as upper surface 533 of first drawer 532.

Each of the plurality of drawers 530 actuates between a retracted position in which the respective drawer 530 is fully within the platform housing 512 and an extended position in which the respective drawer 530 extends at least partially outside the platform housing 512. Each of the plurality of female couplers 150 are configured to detachably and rigidly couple a modular tool storage device to the drawer 530 the female coupler 150 is located on. Each of the plurality of female couplers 150 includes a recessed surface (e.g., see recessed surface 214 in FIG. 6) and a rib (e.g., first rib 226 and/or second rib 228 in FIG. 6) extending over the recessed surface.

Support platform 510 includes a locking plate 630 slidably engaged with the platform housing 512, the locking plate 630 interfacing with each of the plurality of drawers 530. The locking plate 630 actuates between a locked position and an unlocked position such that the locking plate 630 actuates from the unlocked position to the locked position in response to any of the plurality of drawers 530 actuating from the retracted position to the extended position, and the locking plate 630 actuates from the locked position to the unlocked position in response to a drawer 530 of the plurality of drawers 530 actuating from the extended position to the retracted position. When the locking plate 630 is in the locked position no drawers 530 of the plurality of drawers 530 can be actuated from the retracted position to the extended position. Locking plate 630 slides along an axis, such as vertical axis 634, when actuating between the locked position and the unlocked position, such as sliding in upward direction 632 when actuating from the locked position to the unlocked position.

In various embodiments, each of the drawers 530 of the plurality of drawers 530 includes a hooked portion that extends through an aperture of the locking plate 630, similar to or the same as hooked portion 337 of drawers 330 (see FIGS. 8-16).

In various embodiments, the plurality of drawers 530 includes a first drawer 532, and the plurality of female couplers 150 are arranged in a grid located along the first drawer 532. In various embodiments, the grid of female couplers 150 includes at least two columns 560, and more specifically at least four columns 560, and at least two rows 562 of female couplers 150.

In various embodiments, support platform 510 includes a latch recess 158 located along one or more of the drawers 530, such as first drawer 532, the latch recess 158 positioned in front of the grid of female couplers 150. The latch recess 158 is configured to receive a latch extending from the modular tool storage device, the interface between the latch recess 158 and the latch preventing disengagement between the modular tool storage device and the first drawer 532.

In various embodiments, support platform 510 includes a plurality of latch recesses 158 located along one or more of the drawers 530, such as first drawer 532, the plurality of latch recesses 158 positioned in front of the grid of female couplers 150. Each of the latch recesses 158 of the plurality of latch recesses 158 are configured to receive a latch extending from the modular tool storage device, the interface between the latch recess 158 and the latch preventing disengagement between the modular tool storage device and the first drawer 532.

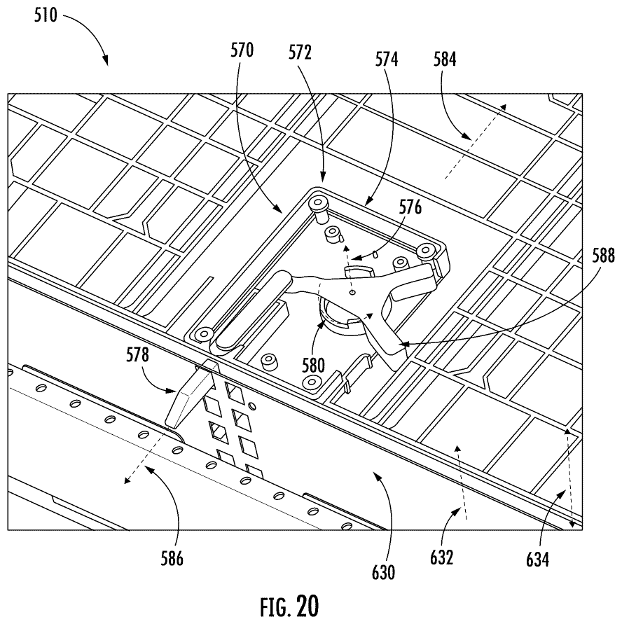

Referring to FIG. 20, support platform 510 includes one or more one or more switches 570, each of which are coupled to a drawer 530, the plurality of switches 570 actuating between a locking position and an unlocked position.

The plurality of switches 570 includes a first switch 572 interfacing with the first drawer 532, and a second switch 570 interfacing with the second drawer 536. The first switch 572 actuates from the unlocked position to the locking position in response to the first drawer 532 actuating from the retracted position towards the extended position, and when the first switch 572 is in the locking position the second drawer 536 is prevented from actuating from the retracted position to the extended position. The second switch 570 actuates from the unlocked position to the locking position in response to the second drawer 536 actuating from the retracted position towards the extended position, and when the second switch 570 is in the locking position the first drawer 532 is prevented from actuating from the retracted position to the extended position.

The first switch 570 includes a switch housing 574 rigidly coupled to the platform housing 512, a cam 588 pivotally coupled to the switch housing 574, and an arm 578 coupled to cam 588, the arm 578 extending through a locking plate 430 coupled to the platform housing 512. Cam 588 rotates about axis 576 with respect to switch housing 574, and thus also platform housing 512. In various embodiments, cam 588 rotates about axis 576 in direction 580 when actuating to the locked position. In various embodiments, the cam 588 is spring biased such that the cam 588 is biased to interface with the arm 578 to extend arm 578 through the locking plate 430 in direction 586. In various embodiments, first drawer 532 interfaces with the cam 588 to retract the arm 578 in direction 584 away from the locking plate 430, e.g., against the spring bias. In various embodiments, as the first drawer 532 is extended from the platform housing 512 in first direction 584, the arm 578 is slidably extended through the locking plate 430. In various embodiments, the plurality of drawers 530 are extended from platform housing 512 in a first direction 584, and the locking plate 630 slides along a vertical axis 634 when actuating between the locked position and the unlocked position that is perpendicular to the first direction 584.

In a specific embodiment, female couplers 150, male couplers 272, latch recesses 158, and latch of modular tool storage device 508 are compatible with the coupling mechanism(s) described in International Patent International Patent Publication No. WO/2017/191628, which is hereby incorporated by reference in its entirety.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A support platform comprising:
a platform housing;
a plurality of drawers slidably coupled to the platform housing, each of the plurality of drawers actuating between a retracted position in which the respective drawer is fully within the platform housing and an extended position in which the respective drawer extends at least partially outside the platform housing;
a plurality of female couplers, each of the plurality of female couplers located along an upper surface of a drawer of the plurality of drawers, wherein each of the plurality of female couplers are configured to detachably and rigidly couple a modular tool storage device to the drawer the female coupler is located on, each of the plurality of female couplers comprising a recessed surface and a rib extending over the recessed surface; and
a locking plate slidably engaged with the platform housing, the locking plate interfacing with each of the plurality of drawers, the locking plate actuating between a locked position and an unlocked position;
wherein the locking plate actuates from the unlocked position to the locked position in response to any of the plurality of drawers actuating from the retracted position to the extended position;
wherein the locking plate actuates from the locked position to the unlocked position in response to a drawer of the plurality of drawers actuating from the extended position to the retracted position;
wherein, when the locking plate is in the locked position, no drawers of the plurality of drawers can be actuated from the retracted position to the extended position.

2. The support platform of claim 1, wherein the plurality of drawers are extended from platform housing in a first direction, and wherein the locking plate slides along a vertical axis when actuating between the locked position and the unlocked position that is perpendicular to the first direction.

3. The support platform of claim 1, wherein each of the drawers of the plurality of drawers comprises a hooked portion that extends through an aperture of the locking plate.

4. The support platform of claim 1, the plurality of drawers comprising a first drawer, the plurality of female couplers arranged in a grid located along the first drawer.

5. The support platform of claim 4, wherein the grid comprises at least four columns and at least two rows of female couplers.

6. The support platform of claim 4, comprising a latch recess located along the first drawer, the latch recess positioned in front of the grid of female couplers, the latch recess configured to receive a latch extending from the modular tool storage device, the interface between the latch recess and the latch preventing disengagement between the modular tool storage device and the first drawer.

7. The support platform of claim 4, comprising a plurality of latch recesses located along the first drawer, the plurality of latch recesses positioned in front of the grid of female couplers, each of the latch recesses of the plurality of latch recesses configured to receive a latch extending from the modular tool storage device, the interface between the latch recess and the latch preventing disengagement between the modular tool storage device and the first drawer.

8. A support platform comprising:
a platform housing;
a plurality of drawers slidably coupled to the platform housing, each of the plurality of drawers actuating between a retracted position in which the respective drawer is fully within the platform housing and an extended position in which the respective drawer extends at least partially outside the platform housing, the plurality of drawers comprising a first drawer and a second drawer;
a plurality of female couplers, each of the plurality of female couplers located along an upper surface of a drawer of the plurality of drawers, wherein each of the plurality of female couplers are configured to detachably and rigidly couple a modular tool storage device to the drawer the female coupler is located on, each of the plurality of female couplers comprising a recessed surface and a rib extending over the recessed surface; and
a plurality of switches coupled to the platform housing, the plurality of switches actuating between a locking position and a unlocked position, the plurality of switches comprising:
a first switch interfacing with the first drawer, wherein the first switch actuates from the unlocked position to the locking position in response to the first drawer actuating from the retracted position towards the extended position, wherein when the first switch is in the locking position the second drawer is prevented from actuating from the retracted position to the extended position; and
a second switch interfacing with the second drawer, wherein the second switch actuates from the unlocked position to the locking position in response to the second drawer actuating from the retracted position towards the extended position, wherein when the second switch is in the locking position the first drawer is prevented from actuating from the retracted position to the extended position.

9. The support platform of claim 8, the first switch comprising a switch housing rigidly coupled to the platform housing, a cam pivotally coupled to the switch housing, and an arm coupled to cam, the arm extending through a locking plate coupled to the platform housing.

10. The support platform of claim 9, wherein the cam is spring biased such that the cam is biased to interface with the arm and extend through the locking plate.

11. The support platform of claim 10, wherein the first drawer interfaces with the cam to retract the arm away from the locking plate.

12. The support platform of claim 11, wherein as the first drawer is extended from the platform housing, the arm is slidably extended through the locking plate.

13. The support platform of claim 8, the plurality of drawers comprising a first drawer, the plurality of female couplers arranged in a grid located along the first drawer, wherein the grid comprises at least two columns and at least two rows of female couplers.

14. The support platform of claim 13, comprising a latch recess located along the first drawer, the latch recess positioned in front of the grid of female couplers, the latch recess configured to receive a latch extending from the modular tool storage device, the interface between the latch recess and the latch preventing disengagement between the modular tool storage device and the first drawer.

15. The support platform of claim 8, comprising a latch recess located along the first drawer, the latch recess positioned in front of the plurality of female couplers, the latch recess configured to receive a latch extending from the modular tool storage device, the interface between the latch recess and the latch preventing disengagement between the modular tool storage device and the first drawer.

16. A storage system comprising:
a modular tool storage device comprising a lower surface and a plurality of male couplers extending from the lower surface, each of the plurality of male couplers comprising a body extending from the lower surface and two tongues extending from the body in opposing directions offset from and displaced from the lower surface; and
a support platform comprising:
a platform housing;
a plurality of drawers slidably coupled to the platform housing, each of the plurality of drawers actuating between a retracted position in which the respective drawer is fully within the platform housing and an extended position in which the respective drawer extends at least partially outside the platform housing;
a plurality of female couplers, each of the plurality of female couplers located along an upper surface of a drawer of the plurality of drawers, wherein each of the plurality of female couplers are configured to engage with the plurality of male couplers thereby detachably and rigidly coupling the modular tool storage device to the drawer the female coupler is located on; and
a locking plate slidably engaged with the platform housing, the locking plate interfacing with each of the plurality of drawers, the locking plate actuating between a locked position and an unlocked position, wherein the locking plate actuates from the unlocked position to the locked position in response to any of the plurality of drawers actuating from the retracted position to the extended position, and the locking plate actuates from the locked position to the unlocked position in response to a drawer of the plurality of drawers in the extended position actuating from the extended position to the retracted position, wherein, when the locking plate is in the locked position no drawers of the plurality of drawers can be actuated from the retracted position to the extended position.

17. The storage system of claim 16, each of the plurality of female couplers comprising a recessed surface and a rib extending over the recessed surface.

18. The storage system of claim 16, wherein the plurality of drawers are extended from platform housing in a first direction, and wherein the locking plate slides along a vertical axis when actuating between the locked position and the unlocked position that is perpendicular to the first direction.

19. The storage system of claim 16, wherein each of the drawers of the plurality of drawers comprises a hooked portion that extends through an aperture of the locking plate.

20. The storage system of claim 16, the plurality of drawers comprising a first drawer, the plurality of female couplers arranged in a grid located along the first drawer.
